(19) United States
(12) Patent Application Publication
(10) Pub. No.: US 2015/0170633 A1
(43) Pub. Date: Jun. 18, 2015

(54) BONE-CONDUCTION NOISE CANCELLING HEADPHONES

(71) Applicant: Kabushiki Kaisha Toshiba, Tokyo (JP)

(72) Inventors: Tooru Nakagawa, Fukaya-shi (JP); Mitsutaka Kuwabara, Fukaya-shi (JP)

(73) Assignee: Kabushiki Kaisha Toshiba, Tokyo (JP)

(21) Appl. No.: 14/267,741

(22) Filed: May 1, 2014

Related U.S. Application Data
(60) Provisional application No. 61/917,166, filed on Dec. 17, 2013.

(51) Int. Cl. G10K 11/178

(52) U.S. Cl. CPC G10K 11/178

(57) ABSTRACT

In a headphone which inhibits noise generated within an ear structure by vibration transmitted through bone, head motion based on vibration is detected by a motion sensor, and a motion signal is output. This motion signal is delayed by a delay time, and the phase of the motion signal is inverted to generate a first noise cancelling acoustic signal in the first cancelling circuit. An acoustic driver of the headphone is driven by the first noise cancelling acoustic signal to inhibit noise.

### CROSS-REFERENCE TO RELATED APPLICATIONS

This application claims the benefit of U.S. Provisional Application No. 61/917,166, filed Dec. 17, 2013, the entire contents of which are incorporated herein by reference.

### FIELD

Embodiments described herein relate generally to a bone-conduction noise cancelling headphone.

### BACKGROUND

In headphones, acoustic drivers are actuated by audio signals from a reproduction device, etc., and acoustic waves from the acoustic drivers are directed toward the eardrums of the ears via the air within the headphones. As a result, sound is heard. In headphones of this type, if extraneous sound intrudes, it becomes difficult to clearly hear or discriminate the acoustic waves from the acoustic drivers. Thus, listening is disturbed.

Because of these factors, noise cancelling headphones have recently been developed. In their acoustic drivers, a noise cancelling wave which cancels external noise is mixed with an acoustic wave in order to cancel noise which intruded into the headphones. Thus, only the acoustic wave which should be essentially heard is directed to the eardrums. More specifically, in noise cancelling headphones, extraneous noise is collected by microphones and converted into a noise signal. The phase of this noise signal is inverted, and an antiphase noise cancelling signal is generated. This signal is given to the acoustic drivers. Therefore, in addition to an acoustic wave for listening, a noise cancelling wave is output from the acoustic drivers. Noise is reduced or negated by the noise cancelling wave within the headphones, and only the acoustic wave for listening is directed to the eardrums.

In addition to the above-described noise which is spread via air, there is bone-conduction noise which is transmitted through bone. With regard to this bone-conduction noise, as long as the noise belongs to an external environmental sound, is an acoustic wave spread via air, is delivered to the external auditory canals within the ears by bone conduction and vibrates the eardrums within the ears, the noise can be reduced by noise cancelling headphones which collect external noise by use of microphones and cancel the noise as described above. However, the bone-conduction noise is not limited to an acoustic wave based on aerial vibration, and there are other vibration components. The bone-conduction noise might be sensed as noise within the ear structure based on other vibration components. Thus, suppression of noise based on the vibration transmitted through bone is more preferable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an explanation drawing illustrating a use state of a noise cancelling headphone according to an embodiment.

FIG. 2 is an explanation drawing illustrating a block of a noise cancelling circuit provided in the noise cancelling headphone shown in FIG. 1 together with an ear structure.

FIG. 3 is a block diagram illustrating a structure of the noise cancelling headphone comprising the noise cancelling circuit shown in FIG. 2.

### DETAILED DESCRIPTION

Various embodiments will be described hereinafter with reference to the accompanying drawings.

According to one embodiment, a headphone which inhibits noise generated by vibration transmitted through bone within an ear structure is provided. In this headphone, a motion sensor detects the motion of the head based on the vibration, and outputs a motion signal. In a first cancelling circuit, the motion signal is delayed by a delay time, and the phase of the motion signal is inverted to generate a first noise cancelling acoustic signal. An acoustic driver is driven by the first noise cancelling acoustic signal to generate a first cancelling acoustic wave. Thus, the noise caused within the ear structure is constrained.

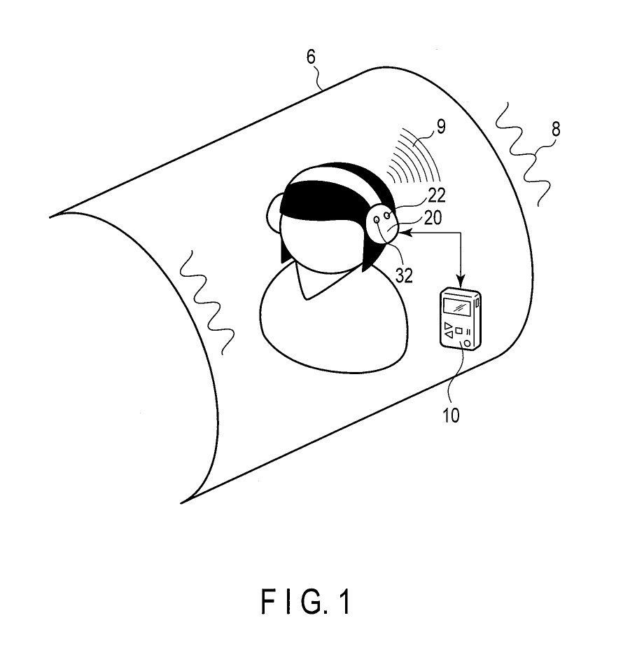

Before explaining the bone-conduction noise cancelling headphone related to the embodiment in detail, this specification explains a mechanism of generation of noise within an ear structure based on vibration transmitted through bone, and detection of the noise with reference to FIG. 1.

Here, as a mechanism of bone conduction, the explanation is given on the premise that vibration is directly delivered to the cranial bone. However, it is obvious that a case in which vibration is indirectly delivered to the cranial bone can be naturally applied.

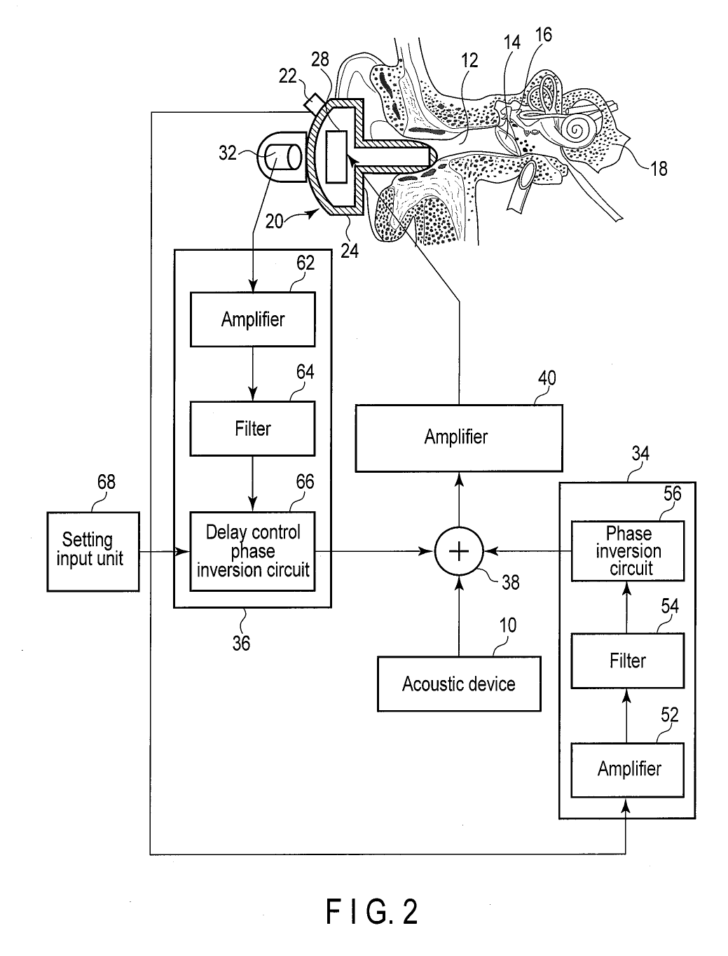

A headphone user wearing headphones 20 does not always listen to music in a quiet environment from an acoustic device 10 such as an audio player as an external device. The headphone user may listen to music in an environment where vibration directly applied to a human body is sensed in a pseudo way as acoustic noise (hereinafter referred to as pseudo-acoustic noise) in addition to acoustic noise spread via air. As this environment, there is a construction site in which vibration is continuously generated, or an environment within a shaking automobile body or airframe, etc., such as a bus or an airplane. In this vibration environment, when a user using headphones 4 props his or her head against a structure such as a pillar or a wall 6, vibration 8 is transmitted to the skin or bone of the headphone user, and the user feels vibration by tactual sense such as pressure sense received in the skin, etc. In addition, the vibration 8 is transmitted through bone, and is sensed as acoustic noise 9 in a pseudo way within the ear structure shown in FIG. 2.

In the ear structure, the sound guided to an external auditory canal 12 vibrates an eardrum 14. This vibration is delivered to an auditory ossicle 16. This delivered vibration agitates the liquid within a cochlear duct 18. This vibration of the liquid is sensed by the spiral organ (also referred to as the organ of Corti, and not shown in the figure) within the cochlear duct 18. This sensed signal is delivered to the brain via the neural transmission system, and is perceived as sound in the brain. The acoustic noise 9 spread via air is sensed as sound by a similar mechanism.

Based on the above mechanism of sound transmission in the ear structure, the inventor focuses attention on the following point. By cancelling or inhibiting only the acoustic wave noise spread via air, the pseudo acoustic noise 9 based on bone-conduction vibration remains, and might be sensed by a headphone user. Here, in order for external vibration not to be transmitted through bone conduction or sensed as acoustic noise, the micromotion or vibration (motion) based on bone conduction vibration is sensed by a motion sensor 32, and the pseudo acoustic noise 9 based on bone conduction vibration is suppressed or cancelled. Here, the micromotion sensed by the motion sensor 32 correlates with the pseudo acoustic noise 9 based on bone conduction vibration. By mixing an acoustic signal or an acoustic wave correlating with the detected micromotion with a reproduction acoustic signal or an acoustic wave, the noise 9 based on bone conduction vibration is inhibited or cancelled. The acoustic signal or acoustic wave correlating with the detected micromotion relies on the physical property (which can be defined by a transfer function) of a bone having high severalty as a conduction medium, etc. Therefore, the acoustic signal or acoustic wave correlating with the detected micromotion is preferably adjusted (calibrated) individually for each headphone user in the specific environment.

More specifically, with regard to the essential acoustic wave generated in an external environment where the vibration vibrating the eardrum 14 as noise is spread via air, if this acoustic wave is detected by a microphone 22, and a noise cancelling signal is generated in a noise cancelling circuit 34 based on the audio signal from the microphone 22, acoustic noise spread via air can be cancelled. However, in a case where the vibration transmitted through bone is directly delivered to the eardrum 14 and transmitted to the auditory ossicle 16 via the eardrum, or is directly delivered to the auditory ossicle 16, similarly, the delivered vibration agitates the liquid within the cochlear duct 18. Therefore, this agitation of the liquid is sensed by the spiral organ (not shown in the figure) within the cochlear duct 18. This sensed signal is delivered to the brain via the neural transmission system, and is perceived as noise sound (pseudo acoustic noise 9) in the brain. This external vibration transmitted through bone cannot be specified (detected) by the microphone 22 which detects an acoustic wave. Thus, the noise (pseudo acoustic noise 9) cannot be cancelled based on the output signal from the microphone 22. Especially, in the normal noise cancelling by the microphone 22, as noise called touch noise of the microphone 22 is reduced, low frequencies are cut. Therefore, it is difficult to reduce low sound (vibration).

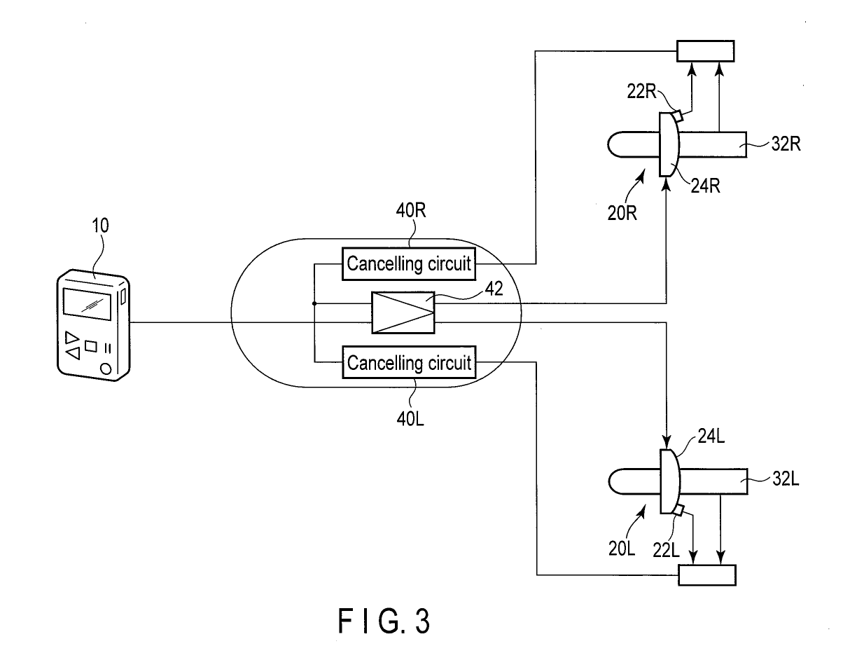

Because of this situation, in the bone-conduction noise cancelling headphones 20, 20R and 20L related to the embodiment shown in FIG. 2 and FIG. 3, motion sensors, such as the vibration sensors or acceleration sensors 32, 32R and 32L, detecting the vibration 8 in the head of the headphone user, particularly, relatively low frequencies, for example, the frequencies of 200 Hz or lower than 200 Hz, are provided on the external surface of housings 24, 24R and 24L of the headphones. The inner surface of the housings 24, 24R and 24L defines the inner cavity. In the inner cavity, an acoustic driver 26 is arranged. Here, the motion sensor 32, 32R or 32L may not be provided in the housing 24, 24R or 24L, and may be provided as a separate unit from the housing 24, 24R or 24L as long as the motion sensor 32, 32R or 32L can detect the vibration 8 in the head of the headphone user. As the frequencies of 200 Hz or lower than 200 Hz are equivalent to the overtones of 100 Hz which is a low frequency, the motion sensors 32, 32R and 32L should detect the frequencies of overtones of the low frequency or lower than the overtones.

There are various types of headphones such as an inner ear type, a canal type, a headband type, a neckband type and an ear hook or clip type. When the motion sensors 32, 32R and 32L are provided in the housings 24, 24R and 24L, the motion sensors 32, 32R and 32L are preferably provided in an inner ear type or canal type of headphones since the inner ear type or canal type of headphones which especially fit the ears including the inner ears easily receive the vibration sensed in the cranial bone.

As the motion sensors 32, 32R and 32L, an element whose main factor is a reaction coefficient (position energy detection) or position detection, etc., such as an acceleration sensor, is used since the headphones 20, 20R and 20L themselves vibrate. When an acceleration sensor is used as the motion sensors 32, 32R and 32L, the signal from the acceleration sensor is time-integrated for each certain time, and an integral signal is output as bone vibration. When an acceleration sensor is employed as the motion sensors 32, 32R and 32L, in the acceleration sensor, a time integration circuit is provided in the sensor element as one unit or a separate unit. Further, as the motion sensors 32, 32R and 32L, a magnetic fluid type of sensor as a vibration sensor may be used. The magnetic fluid type of sensor comprises a structure in which a coil is movable in the magnetic fluid. By electromagnetically detecting the coil which moves in the magnetic fluid, the vibration applied to the magnetic fluid type of sensor can be detected.

The vibration transmitted through bone is three-dimensionally spread through bone, especially, a cranial bone. Essentially, the hearing sensitivity is high within a flat surface including right and left ears. The motion sensors 32, 32R and 32L are preferably placed in order to at least detect the vibration transmitted in a direction within the flat surface, more specifically, the front-back direction or right-left direction of the head. Obviously, in addition to the direction on the flat surface (front-back direction or right-left direction of the head), two or more than two motion sensors 32, 32R or 32L may be provided in order to detect the direction orthogonal to the flat surface (the direction within the flat surface including the body trunk axis including the head).

FIG. 2 shows an embodiment in which the headphones 20R and 20L are mounted on the right and left ears. In addition to the motion sensors 32R and 32L, the microphones 22R and 22L which detect air propagation noise are provided in the headphones 20R and 20L. The audio signal detected as audio noise in the microphones 22R and 22L and the motion signal detected in the motion sensors 32R and 32L are given to noise cancelling circuits 40R and 40L via a signal line. The audio signal is phase-reversed and amplified in the noise cancelling circuits 40R and 40L, and added to the audio signal from the external device 10 in an amplifier 42. Similarly, in the noise cancelling circuits 40R and 40L, the delay of the motion signal is controlled by only the predetermined delay time depending on the detected signal frequency, and the motion signal is phase-reversed and amplified. The motion signal is added to the audio signal from the external device 10 in the amplifier 42. The output signal from the amplifier 42 is given to the headphones 20R and 20L. From the headphones 20R and 20L, an acoustic signal is directed to the eardrums 14 via the external auditory canals 12. Here, the acoustic wave from the headphones 20R and 20L contains a cancelling audio wave whose phase is reversed relative to the audio signal as audio noise detected in the microphones 22R and 22L. Therefore, the audio noise which entered the headphones 20R and 20L is cancelled or constrained by this antiphase cancelling audio wave. Thus, the eardrums 14 are vibrated by a pseudo noise cancelling audio wave generated based on the vibration detected in the motion sensors 32R and 32L, together with the acoustic wave which comes from the acoustic device 10 and should be essentially reproduced. This vibration is delivered to the auditory ossicles 16. This delivered vibration agitates the liquid within the cochlear ducts 18. This vibration of the liquid is sensed by the spiral organs (not shown in the figure) in the cochlear ducts 18. Here, the pseudo noise cancelling audio wave is configured to agitate the liquid within the cochlear ducts 18 with the substantially antiphase of the pseudo acoustic noise 9. Therefore, the pseudo noise cancelling audio wave is transmitted to the cochlear ducts 18 in order to inhibit or cancel the vibration of the pseudo acoustic noise 9 which agitates the liquid within the cochlear ducts 18. Thus, it is possible to create a state as if the pseudo acoustic noise 9 is not delivered within the cochlear ducts 18. Only the sensed signal equivalent to the acoustic wave which comes from the acoustic device 10 and should be essentially reproduced is delivered to the brain via the neural transmission system. Thus, the state is detected as a state at which substantially there is no noise or noise is inhibited in the brain.

More specifically, as shown in FIG. 3, each of the noise cancelling circuits 40R and 40L is structured from the audio noise cancelling circuit 34 and a pseudo acoustic noise cancelling circuit 36. The audio noise cancelling circuit 34 is connected to the microphone 22 via a signal line, and the pseudo acoustic noise cancelling circuit 36 is connected to the motion sensor 32 via a signal line. Each of the audio noise cancelling circuit 34 and the pseudo acoustic noise cancelling circuit 36 is connected to an adder 38 of the amplifier 42. The adder 38 is connected to the acoustic device 10 as an external device. The accumulator 38 is connected to the acoustic device 10 as an external device. In the adder 38 of the amplifier 42, the audio noise cancelling signal from the audio noise cancelling circuit 34 and the pseudo acoustic noise cancelling signal from the pseudo acoustic noise cancelling circuit 36 are added to the audio signal which is supplied from the acoustic device 10 and should be reproduced. The addition audio signal added in the adder 38 is amplified in the amplifier 40 for the headphone within the amplifier 42, and is supplied to an audio driver 28 of the headphone 20. Therefore, as described above, the audio driver 28 generates a cancelling audio wave whose phase is inverted relative to an audio signal as audio noise, and a pseudo acoustic noise cancelling wave for cancelling an acoustic wave which should be essentially reproduced and pseudo acoustic noise, and the audio driver 28 outputs the generated waves toward the eardrum 14.

The audio noise cancelling circuit 34 is composed of an amplifier 52 which amplifies the audio signal from the microphone 22, a filter 54 which filters the amplified audio signal, and a phase inversion circuit 56 which inverts the phase of the filter audio signal. An acoustic noise cancelling signal whose phase is reversed relative an acoustic noise signal is output from the phase inversion circuit 56 to the adder 38. The filter 54 cuts frequencies of 200 Hz or lower than 200 Hz. Similarly, sounds in a high range (higher than a few kHz) are cut by the filter 54 as it is difficult to erase the high-range sounds by the antiphase audio noise cancelling signal. Therefore, by the filter 54, an audio noise cancelling signal is set to be an audio signal of 200 Hz or higher than 200 Hz, mainly, an audio signal within the range of 200 Hz to 3 kHz.

The pseudo acoustic noise cancelling circuit 36 is composed of an amplifier 62 which amplifies the motion signal from the motion sensor 32 as pseudo acoustic noise, a filter 64 which filters the amplified motion signal, and a phase inversion circuit 66 which controls the phase of the filter motion signal and inverts the phase. A pseudo acoustic noise cancelling signal in which the phase of a pseudo acoustic noise signal is inverted is output toward the adder 38 from the phase inversion circuit 66.

The vibration as pseudo acoustic noise of 200 Hz or lower than 200 Hz detected by the motion sensor 32 is normally limited to the periodic vibration (stationary vibration). The reason for this is because the vibration is a vibration having a relatively low frequency given from outside in association with a machine vibration, for example, a machine vibration from an engine. The vibration is determined relatively unambiguously by the operation situation of the machine, etc. Therefore, by appropriately setting a delay time in the delay control and phase inversion circuit 66 by an external setting input unit 68, a pseudo acoustic noise cancelling signal can be appropriately set. Preferably, in an environment where noise is generated, for example, within an in-flight airplane, the delay control and phase inversion circuit 66 is set by the parameter determined by the setting input unit 68 in order to set the delay time.

In an environment where noise is generated, the frequency of vibration is projected in advance. For example, the frequency of machine vibration of a train at the time of steady operation is projected in advance. Therefore, machine vibration (vibration mode) of a train at the time of steady operation may be selected in the setting unit 68, and the setting unit 68 may correct the feature in which the neural system of the head is individually different as a vibration conduction medium by applying external vibration to the head of a headphone user from outside, for example, from a mobile phone by the use of the vibration function of the mobile phone while the train stops or at the state where machine vibration is not generated. The feature of the vibration conduction system of the head may be set by applying vibration to the head from outside, changing the delay time in the setting unit 68 in various ways and setting an optimal value, and after that, machine vibration (vibration mode) of a train at the time of steady operation may be selected in the setting unit 68. By this setting, it is possible to realize the optimal setting in the external environment, and certainly constrain or cancel the noise components detected as noise within the ear structure based on the vibration transmitted through bone. In general, a transfer function varies depending on the person because of the difference in the length of the inner ears and the ear structure. This causes differences in the noise generation band in the ear structure. However, noise components can be surely restrained or cancelled by the prior setting by the setting unit 68.

More preferably, in consideration of the influence of the frequency property of the inner ears, the feature of the filter can be also adjusted in detail by the input signal from the setting unit 68 in order to adjust the frequency which is not the target of noise reduction.

In the circuit shown in FIG. 2, the audio signals detected as audio noise in the microphone 22 and the motion signals detected in the motion sensor 32 are given to the noise cancelling circuits 34 and 36, and are amplified in the amplifiers 52 and 62. The audio signals are filtered into audio signals within the range of 200 Hz to 3 kHz in the filter circuit 54, and are phase-reversed in the phase inversion circuit 56. These phase-reversed noise cancelling audio signals are added to the audio signals for reproduction from the external device 10 in the adder 38.

Similarly, the amplified motion signals are filtered into a band of 200 Hz or lower than 200 Hz in the filter circuit 64. The delay of the amplified motion signals are controlled by only the delay time set in the setting input portion 68, and the amplified motion signals are phase-reversed. The delay-controlled and phase-reversed motion signals are added to the audio signals for reproduction from the external device 10 in the adder 38 as pseudo noise cancelling audio signals in the same manner as the noise cancelling audio signals. The output signals from the adder 38 are given to the acoustic driver 28 of the headphone 20. The acoustic signals are directed to the eardrum 14 from the acoustic driver 28 via the external auditory canal 12. Here, since the acoustic wave from the acoustic driver 28 contains a cancelling audio wave whose phase is inverted relative to the audio signal as audio noise detected in the microphone 22, the audio noise which broke into the headphone 20 is cancelled or constrained by the antiphase cancelling audio wave. Therefore, the eardrum 14 is vibrated by the pseudo noise cancelling audio wave generated based on the vibration detected in each of the motion sensors 32R and 32L together with the acoustic wave which comes from the acoustic device 10 and should be essentially reproduced. This vibration is delivered to the auditory ossicle 16. This delivered vibration agitates the liquid within the cochlear duct 18, and is sensed in the spiral organ within the cochlear duct 18. Here, the phase of the pseudo noise cancelling audio wave is substantially inverse relative to the pseudo acoustic noise 9, and the pseudo noise cancelling audio wave is configured to agitate the liquid within the cochlear duct 18. Therefore, the pseudo noise cancelling audio wave is delivered to the cochlear duct 18 in order to inhibit or cancel the vibration of the pseudo acoustic noise 9 which agitates the liquid within the cochlear duct 18. Thus, it is possible to create a state as if the pseudo acoustic noise 9 is not delivered within the cochlear duct 18. Only the sensed signal equivalent to the acoustic wave which comes from the acoustic device 10 and should be essentially reproduced is delivered to the brain via the neural transmission system. In this manner, the state is detected as a state at which substantially noise does not exist or is inhibited in the brain.

As described above, according to the noise cancelling headphone related to the embodiments, it is possible to inhibit or delete the noise which is caused by bone conduction and detected as noise within an ear structure as well as an acoustic wave based on air vibration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A headphone which inhibits noise generated within an ear structure by vibration transmitted through bone, the headphone comprising:
a motion sensor which detects motion of a head based on the vibration and outputs a motion signal;
a first cancelling circuit which delays the motion signal by a delay time and generates a first noise cancelling acoustic signal by inverting a phase of the motion signal; and
an acoustic driver which is driven by the first noise cancelling acoustic signal and generates a first cancelling acoustic wave.

2. The headphone according to claim 1, further comprising:
a microphone which detects acoustic noise generated in an external environment and outputs an acoustic noise signal;
a second cancelling circuit which generates a second noise cancelling acoustic signal by inverting a phase of the acoustic noise signal; and
an adding circuit which sums the first noise cancelling acoustic signal and the second noise cancelling acoustic signal, and outputs an addition noise cancelling acoustic signal.

3. The headphone according to claim 2, wherein the second cancelling circuit comprises:
a filter circuit which filters the acoustic noise signal and outputs a filtered acoustic noise signal having a frequency in a band of 200 Hz to 3 kHz; and
a delay phase inversion circuit which delays the filtered acoustic noise signal and generates a second noise cancelling acoustic signal by inverting a phase of the filtered acoustic noise signal.

4. The headphone according to claim 2, wherein an acoustic signal to be reproduced is input from an external acoustic device to the adding circuit, and the acoustic signal to be reproduced is added to the addition noise cancelling acoustic signal and is output.

5. The headphone according to claim 1, wherein the first cancelling circuit comprises:
a filter circuit which filters the motion signal and outputs a filtered motion signal having a frequency of 200 Hz or less than 200 Hz; and
a delay phase inversion circuit which delays the filtered motion signal and generates a first noise cancelling acoustic signal by inverting a phase of the filtered motion signal.

6. The headphone according to claim 1, wherein the acoustic driver further comprises a housing having a cavity inside, and the motion sensor is fixed on the housing and detects motion of the housing.

7. The headphone according to claim 1, wherein the motion sensor comprises an acceleration sensor which detects acceleration and outputs an acceleration signal, and the acceleration signal is time-integrated and is output as a motion signal.

8. The headphone according to claim 1, wherein the motion sensor comprises a vibration sensor which detects vibration.

9. A method for inhibiting noise generated within an ear structure by vibration transmitted through bone by a headphone, the method comprising:
detecting motion of a head based on the vibration and outputting a motion signal,
delaying the motion signal by only a delay time and generating a first noise cancelling acoustic signal by inverting a phase of the motion signal; and
generating a first cancelling acoustic wave by the first noise cancelling acoustic signal within the headphone.
